(19) United States
(12) Patent Application Publication
(10) Pub. No.: US 2008/0243639 A1
(43) Pub. Date: Oct. 2, 2008

(54) PLANT MERCHANDISING SYSTEM AND METHOD

(76) Inventor: Jayme A. Mullaney, Boise, ID (US)

Correspondence Address: Joseph W. Holland;HOLLAND LAW OFFICE PLLC, P.O. Box 1840, Boise, ID, 83701-1840, US

(21) Appl. No.: 11/695,317

(22) Filed: Apr. 2, 2007

(51) Int. Cl. G06F 19/00

(52) U.S. Cl. 705/27; 705/1

(57) ABSTRACT

A plant merchandising display provides for the display of plants in arrays, groupings and sets based on one or more product characteristics such that a customer may readily associate product selection criteria and product characteristics to resulting in satisfactory product selections. A plant merchandising system and program includes the plant merchandising display as well as a landscape design module that includes garden design tools to assist a customer in planning an entire landscape or a single garden. The plant merchandising system and program also include a plant directory that allows a customer to view plant information and make plant selections and plant maintenance guides to assist customers in planning and scheduling garden maintenance. Purchase documents may be created at a purchase order processing module from garden plans developed in the landscape design module and plant lists developed at the plant directory or in the plant merchandising display.

### BACKGROUND OF THE INVENTION

1. Technical Field

The present invention relates generally to methods and devices for product merchandising and more particularly to a system and method for the display and sale of garden plants including a garden design system.

2. Background of the Invention

The merchandising of consumer products in a manner that permits a potential customer to better visualize the product in use at a time or location remote from the display remains a challenge. The merchandising of a product having a nascent quality is particularly challenging in that even in those instances wherein the product in its present condition may be satisfactorily displayed in a manner that meets certain merchandising criteria, the customer may nevertheless feel that certain purchasing expectations were not met once the product is placed in use or once the nascent characteristics of the product emerges.

For example, such a challenge has been encountered historically by those who market and sell horticultural and garden plants. For those persons attempting to design a garden or procure plants for a garden design, a similar challenge is encountered. More specifically, persons who may be engaged in garden design or the procurement of plants for a garden design tend to have design skills and knowledge and familiarity with the variety of available species for landscaping that range from expert to absolute novice. It has been observed that typical consumers of garden plants do not command a complete familiarity of the vast number of available species for landscaping and the elements of design. Given the additional fact that the floral elements of a garden design change over the course of time, for instance in size and color due to growth and blooming cycles, the task becomes even more difficult. Add to this the fact that a preferred set of flora for any given geographical or growing area may change dramatically, the amateur home gardener is clearly at a disadvantage. Nevertheless, annual sales of garden plants to amateur gardeners has always accounted for a substantial portion of overall annual sales.

To further illustrate these points, all one must do is visit a nursery in the spring. Trees and shrubs are typically found in one section separated often by species and occasionally by present height. Flowering plants are typically laid out on flats or tables separated, if at all, as annuals or perennials, all relatively of the same height, depending on the time of year, with few, if any, having declared their blossom color. In order to find some sense of organization or design the gardener commonly looks to the stick cards that are often included in the plants container. A novice gardener in this setting may arrive at the nursery with little or no concept of the garden that they wish to achieve or how their plan may best be realized. So equipped, the gardener pushes a cart through aisle after aisle of plants making selections based often on too little information and ultimately with an inadequate sense of overall design. In the end, the garden or bed reflects the limitations of this method of marketing to a customer having only casual knowledge of gardening. Even the well practiced gardener often has difficulty simply locating a desirable species in the described setting.

A garden, by nature, is an undertaking that changes and evolves over time. Similarly, landscaping and gardening are time consuming activities and for the home gardener or amateur gardener, the installation of one or more gardens may take several weeks. As such, gardeners may finds themselves visiting the nursery repeatedly in order to complete a project. Nevertheless the gardener may find themselves experiencing a sense of “starting all over” every time they visit the nursery.

Advantage may therefore be found in a merchandising display, system and method that provides for the display of garden plants in arrays, groupings and sets, each based on one or more plant characteristics such that a customer may readily associate plant selection criteria and plant characteristics to arrive at satisfactory plant selections. Advantage may also be found in a merchandising display, system and method that provides for the display of garden plants wherein a display is based on one or more plant characteristics and selected design rules such that a customer may readily associate plant selection criteria and plant characteristics to arrive at satisfactory plant selections. Advantage may also be found in providing a merchandising display, system and method that assists a customer in developing plant selection criteria and ultimately a purchase order for plants based on customer specified criteria, selected design rules, defined plant compatibility criteria and customer selections in view of the customer specified criteria, selected design rules, defined plant compatibility criteria. Similarly, advantage may be found in providing a merchandising display, system and method for assisting a customer in developing landscape and garden designs that includes plant selection criteria, which in turn would assist the customer in choosing plants from a display of plants arranged and presented in arrays groupings and sets, real or simulated, the arrays, groupings and sets based on one or more plant characteristics such that the customer may readily associate product selection criteria and product characteristics to arrive at satisfactory product selections.

One object of the present invention therefore is providing a merchandising display, system and method that provides for the display of garden plants in arrays based on one or more plant characteristics such that a customer may readily associate plant selection criteria and plant characteristics to arrive at satisfactory plant selections. Another object of the present invention is providing a merchandising display, system and method that provides for the display of garden plants wherein a display is based on one or more plant characteristics and selected design rules such that a customer may readily associate plant selection criteria and plant characteristics to arrive at satisfactory plant selections. Yet another object of the present invention is to provide a merchandising display, system and method that assists a customer in developing plant selection criteria and ultimately a purchase order for plants based on customer specified criteria, selected design rules, defined plant compatibility criteria and customer selections in view of the customer specified criteria, selected design rules, defined plant compatibility criteria. An additional object of the present invention is providing a merchandising display, system and method that could assist a customer in developing landscape and garden designs and assisting the customer in choosing plants from displays of plants arranged and presented in arrays, real or simulated, the arrays based on one or more plant characteristics such that the customer may readily associate product selection criteria and product characteristics to arrive at satisfactory product selections. A further object of the present invention is to provide a system and method that could, with minimal input by the customer, develop landscape and garden designs and propose or select recommended plants for those gardens, producing a purchase order from which delivery or shipping documents could be prepared.

### SUMMARY OF THE INVENTION

The present invention is directed to a merchandising display, system, method and program that provides for a display of products in arrays, groupings and sets based on one or more product characteristics such that a customer may readily associate product selection criteria and product characteristics resulting in satisfactory product selections. The present invention is also directed to a display, system and method that provides for the display of products wherein a display array is based on one or more product characteristics selected from a grouping of product characteristics including apparent characteristics, nascent characteristics and selected design rules such that a customer may readily associate product selection criteria and product characteristics to arrive at satisfactory product selections.

In one preferred embodiment, a plant merchandising display includes one or more relational plant arrays or other sub-displays including groupings, sub-groupings, sets, sub-sets or the like. Each plant in a particular array, sub-arrays or other sub-displays including groupings, sub-groupings, sets, sub-sets or the like, shares a particular plant characteristic, for instance, blossom season, blossom color, mature plant height, sun or shade exposure and watering needs. Additionally, each plant in a particular array, sub-arrays or other sub-displays including groupings, sub-groupings, sets, sub-sets or the like, may share a particular plant characteristic that addresses a particular garden design objective that relates to the impact or use that the intended garden is to have, for example, whether the garden or planting is intended as a formal or informal planting, or whether the garden is intended to produce cut flowers or serve as a hedge or screen or whether the garden is intended as a planting that will attract certain wildlife for instance birds or butterflies.

In another preferred embodiment, a plant merchandising system may include a landscape design module that assists a customer in planning an entire landscape or a single garden. The plant merchandising system may also include a plant directory, a resource that allows a customer to view plant information and make plant selections without entering the plant merchandising display. Plant maintenance guides may also be made available to assist customers in planning and scheduling garden maintenance. The plant merchandising system may also include a display wherein plants are displayed in one or more relational plant arrays or other sub-displays including groupings, sub-groupings, sets, sub-sets or the like. Purchase documents may be created at a purchase order processing module from garden plans developed in the landscape design module and plant lists developed at the plant directory or in the plant merchandising display. Details regarding physical selection of plants, plant pick-up and/or delivery may be arranged for at the purchase order processing module.

A computer-implemented plant merchandising system includes a computer operable plant merchandising program operable on a local or networked computer. The plant merchandising program includes a landscape design module, a plant selection module, a garden display module and a purchase order processing module.

A method for merchandising horticultural plants according to the present invention includes selecting or in the alternative developing a garden template, viewing one or more relational plant arrays, each of the one or more relational plant arrays including a plurality of plants arranged according to a plant characteristic, selecting a plant from one of the one or more relational plant arrays and displaying a selected plant on a selected plant list.

The present invention consists of the parts hereinafter more fully described, illustrated in the accompanying drawings and more particularly pointed out in the appended claims, it being understood that changes may be made in the form, size, proportions and minor details of construction without departing from the spirit or sacrificing any of the advantages of the invention.

### BRIEF DESCRIPTION OF THE DRAWINGS

FIG. 1 is a representative schematic of a plant merchandising system according to the present invention;

FIG. 2 is a representative schematic of a plant merchandising system according to the present invention;

FIG. 3 is a representative schematic of a plant merchandising system according to the present invention;

FIG. 4 is a representative schematic of a plant merchandising display according to the present invention;

FIG. 5 is a representative schematic of a plant merchandising system according to the present invention;

FIG. 6 is a representative schematic of a plant merchandising display according to the present invention;

FIG. 7 is a representative schematic of a system for operating a plant merchandising program according to the present invention;

FIG. 8 is a representative schematic of a system for operating a plant merchandising program according to the present invention;

FIG. 9 is a schematic flowchart depicting architecture for plant merchandising program according to the present invention.

### DETAILED DESCRIPTION

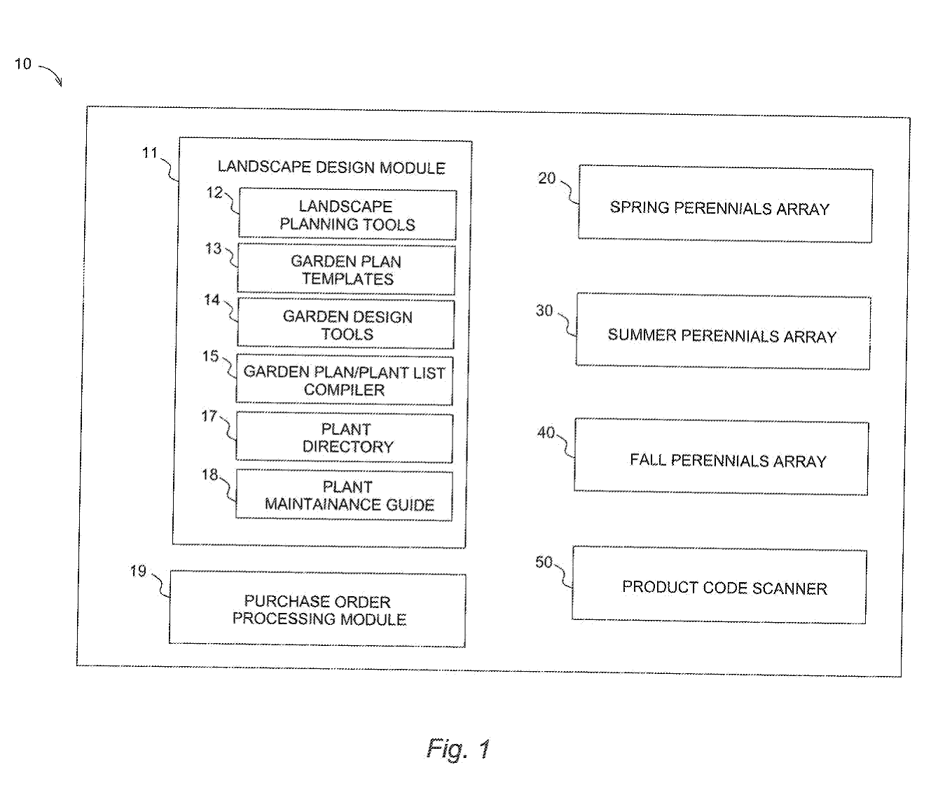

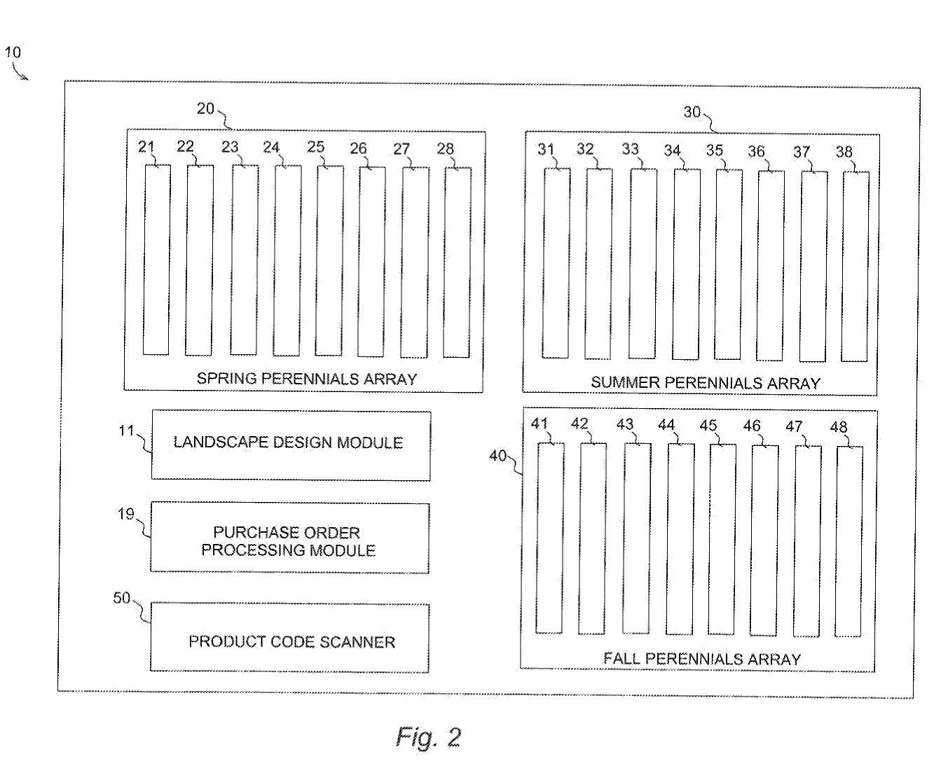

Referring to FIGS. 1 and 2, plant merchandising system 10 is shown including landscape design module 11, purchase order processing module 19 and a plurality of plant arrays including spring perennials array 20, summer perennials array 30 and fall perennials array 40. Plant merchandising system 10 may also include a handheld scanner 50, which allows a gardener to scan barcode information found at the location of an actual plant or in the alternative at the plant directory 16 as discussed in greater detail herein. As shown FIG. 1, landscape design module 11 includes landscape design tools 12 that aide a customer in planning an entire landscape if desired. The customer may input property size and characteristics and garden areas may be suggested or selected at garden plan templates 13 or designed by the customer using garden design tools 14. Landscape design module 11 provides a central location that provides information to a gardener relating to landscape and garden planning and plant selection. Garden plan templates 13 provides the customer with selectable garden templates or pre-selected garden, templates based on limited user input. The gardener may select one or more pre-designed gardens or plantings from a variety of templates presented at garden plan templates 13.

In the event that the gardener desires to take a more active roll in the design of the planting, landscape design module 11 provides additional tools to assist the gardener. Garden design tools 14 presents information to the gardener that aides in the selection of the planting type desired by the gardener, for instance assisting the gardener in determining whether the planting is intended to be established against a backdrop, for example an outer wall of a house or other structure, and if so what the predominant background color may be or whether the planting is to be established in an open area. Additionally, garden design tools 14 may assist the gardener in determining a configuration and size for the planting for which the gardener intends to purchase plants. Garden design tools 14 also includes garden design objectives that relate to the impact or use that the intended planting is to have, for example, whether the garden or planting is intended as a formal or informal planting, or whether the garden is intended to produce cut flowers or serve as a hedge or screen. Alternately, the gardener may have as a design objective establishing a planting that will attract certain wildlife for instance birds or butterflies. Furthermore, garden design tools 14 assists the gardener in determining a predominant color scheme for the desired planting. Garden design tools 14 may assist the gardener in determining the physical or environmental requirements of the planting. For example the gardener will need to determine the watering requirements for the planting as well as the degree of sun or shade the planting will experience at its intended location.

Once a desired landscape and/or garden plan is developed in landscape design module 11, a garden plan/proposed plant list may be output at garden plan/proposed plant list compiler 15. Garden plan/proposed plant list compiler 15 may provide output in any of a number of formats. For example, output may include simply a printed list of suggested plants and alternatives, or in the alternative an actual plan template may be printed that not only lists suggested plants and alternatives but indicates the proposed planting location for each plant. Alternately, an output may be uploaded to handheld product scanner 50, or saved on a personal computer locally or over a network either local or web-based, so that the gardener may save and edit garden plans or plant lists output by garden plan/proposed plant list compiler 15 as discussed herein below.

As shown in FIG. 1, landscape design module 11 also includes plant directory 17 that provides plant listings and information arranged in a traditional manner, by genus and species, or in substantially the same manner as the actual plants are arranged in the plurality of plant arrays 20-40. Additionally plant directory 17 may include a photographic or pictorial display of the plants available in a given array together with a bar code for the plant. A shopper at her option may simply choose to scan the bar code of a desired plant using handheld scanner 50, adding the desired plant to garden plan/proposed plant list 16. Plant directory 17 also includes detailed information relating to each plant including size and height at maturity, predominant blossom color, blossom season and preferred watering and sunlight conditions. Plant maintenance guides 18 provide information relating to care and maintenance of plants and are made available to assist the gardener in properly caring for the selected plants.

As shown in FIG. 1 plant merchandising system 10 also includes a plurality of plants arranged according to plant characteristics. FIG. 1 shows spring perennials array 20, summer perennials array 30 and fall perennials array 40 which comprise relational plant arrangements in the sense that each of the plant arrays includes a plurality of plants arranged according to a plant characteristic. In this case, plants are arranged according to the season in which the plants blossom. It is to be understood that plant merchandising system 10 may include other arrays. For instance, in some climates winter gardens are common and even prominent and it is contemplated that winter plant arrays would be appropriate in these locales. Additionally, arrays of annual plants, shrubs or other landscaping elements, or that all elements could be included in any particular seasonal array, i.e. spring blooming perennials, shrubs, annuals and trees would all be displayed in a spring array and these are as well contemplated to be within the scope of the present invention.

Referring to FIG. 2, a plurality of relational plant arrangements include spring perennials array 20, summer perennials array 30 and fall perennials array 40 are shown to greater advantage. More particularly, FIG. 2 shows the relational plant arrangements divided in this case not only as to blossom season but in this case as to groupings based on predominant blossom color. In this case grouping 21 represents plants having substantially yellow blossoms, grouping 22 represents plants having substantially orange blossoms, grouping 23 represents plants having substantially red blossoms, grouping 24 represents plants having substantially black blossoms, grouping 25 represents plants having substantially purple blossoms, grouping 26 represents plants having substantially blue blossoms, grouping 27 represents plants having substantially green blossoms and grouping 28 represents plants having substantially white blossoms, all within spring perennials array 20. Similarly, grouping 31 represents plants having substantially yellow blossoms, grouping 32 represents plants having substantially orange blossoms, grouping 33 represents plants having substantially red blossoms, grouping 34 represents plants having substantially black blossoms, grouping 35 represents plants having substantially purple blossoms, grouping 36 represents plants having substantially blue blossoms, grouping 37 represents plants having substantially green blossoms and grouping 38 represents plants having substantially white blossoms, all within summer perennials array 30. Likewise grouping 41 represents plants having substantially yellow blossoms, grouping 42 represents plants having substantially orange blossoms, grouping 43 represents plants having substantially red blossoms, grouping 44 represents plants having substantially black blossoms, grouping 45 represents plants having substantially purple blossoms, grouping 46 represents plants having substantially blue blossoms, grouping 47 represents plants having substantially green blossoms and grouping 48 represents plants having substantially white blossoms, all within summer perennials array 40.

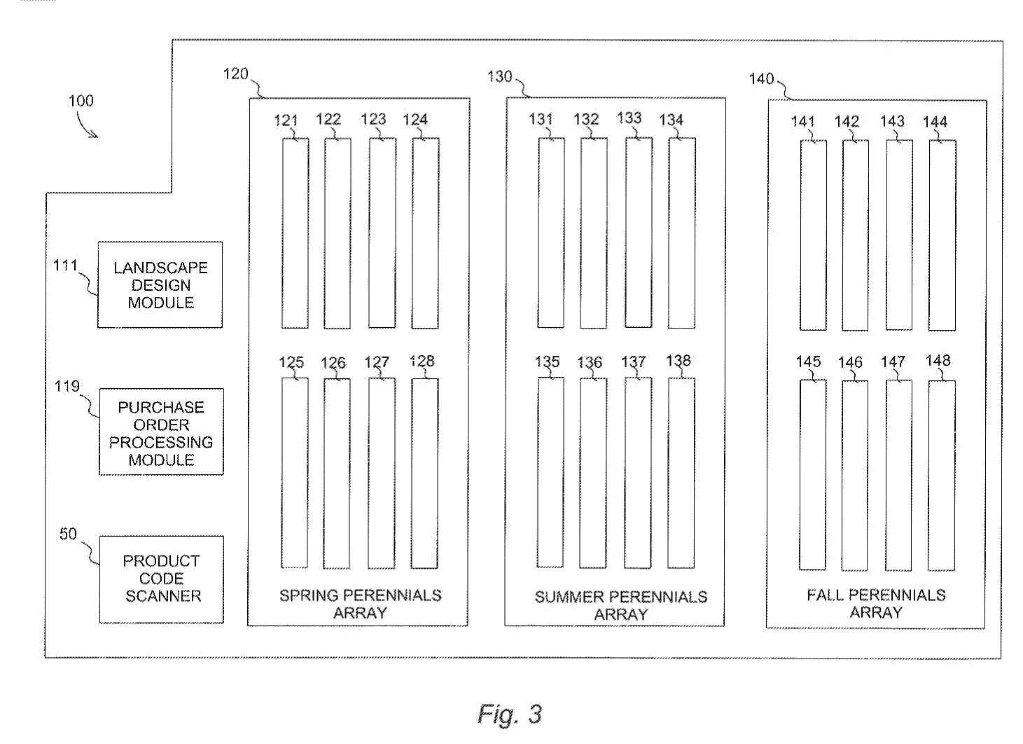

Referring to FIG. 3, plant merchandising system 100 is shown including landscape design module 111, purchase order processing module 119 and a plurality of plant arrays including spring perennials array 120, summer perennials array 130 and fall perennials array 140. Plant merchandising system 100 may also include a handheld scanner 50. FIG. 3 shows the relational plant arrays divided in this case not only as to season of blossoming and predominant blossom color, but in the case of plant merchandising system 100, the groupings comprising the arrays are sorted such that plants having complimentary blossom colors are set opposite from one another, providing one more visual cue to the gardener or garden planner. Referring to spring perennials array 120, grouping 121 represents plants having substantially yellow blossoms and is positioned such that it opposes grouping 125 which represents plants having complimentary and substantially purple blossoms. Similarly grouping 122 represents plants having substantially orange blossoms and is positioned such that it opposes grouping 126 which represents plants having complimentary and substantially blue blossoms. Likewise grouping 123 represents plants having substantially red blossoms and is positioned such that it opposes grouping 127 which represents plants having complimentary and substantially green blossoms. Finally, grouping 124 represents plants having substantially black blossoms and is positioned such that it opposes grouping 128 which represents plants having complimentary and substantially white blossoms.

Summer perennials array 130 includes grouping 131 which represents plants having substantially yellow blossoms and is positioned such that it opposes grouping 135 which represents plants having complimentary and substantially purple blossoms. Similarly grouping 132 represents plants having substantially orange blossoms and is positioned such that it opposes grouping 136 which represents plants having complimentary and substantially blue blossoms. Likewise grouping 133 represents plants having substantially red blossoms and is positioned such that it opposes grouping 137 which represents plants having complimentary and substantially green blossoms. Finally, grouping 134 represents plants having substantially black blossoms and is positioned such that it opposes grouping 138 which represents plants having complimentary and substantially white blossoms.

Referring to fall perennials array 140, grouping 141 represents plants having substantially yellow blossoms and is positioned such that it opposes grouping 145 which represents plants having complimentary and substantially purple blossoms. Similarly grouping 142 represents plants having substantially orange blossoms and is positioned such that it opposes grouping 146 which represents plants having complimentary and substantially blue blossoms. Likewise grouping 143 represents plants having substantially red blossoms and is positioned such that it opposes grouping 147 which represents plants having complimentary and substantially green blossoms. Lastly, grouping 144 represents plants having substantially black blossoms and is positioned such that it opposes grouping 148 which represents plants having complimentary and substantially white blossoms.

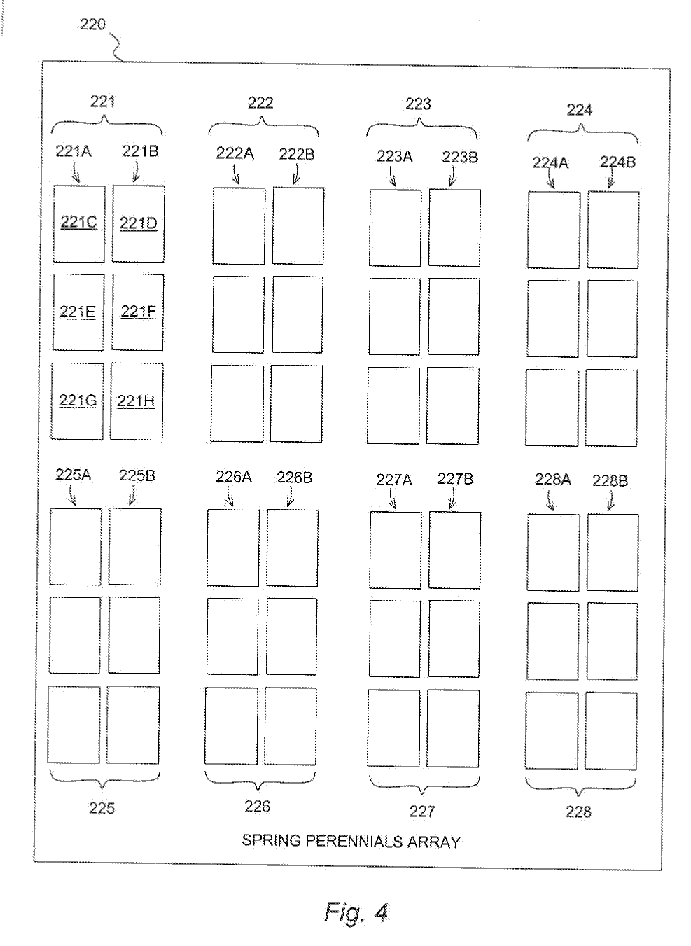

Referring to FIG. 4, spring perennials array 220 is shown divided still further into a plurality of groupings and sets, each representing relational plant arrays arranged according to distinct plant characteristics. More particularly, FIG. 4 shows spring perennials array 220 including a plurality of groupings 221, 222, 223, 224, 225, 226, 227 and 228, which in turn are respectively divided into sub-groupings 221A and 221B, 222A and 222B, 223A and 223B, 224A and 224B, 225A and 225B, 226A and 226B, 227A and 227B and 228A and 228B. Each of the referenced sub-groupings are defined by a plant characteristic, in this case relative sun or shade exposure.

Sub-grouping 221A represents plants that are relatively sun tolerant and have substantially yellow blossoms, while sub-grouping 221B represents plants that are relatively shade tolerant having substantially yellow blossoms. Sub-groupings 221A and 221B are positioned such that they oppose sub-groupings 225A and 225B which represents plants having complimentary and substantially purple blossoms and which are respectively relatively sun or shade tolerant. Similarly, sub-grouping 222A represents plants that are relatively sun tolerant and have substantially orange blossoms, while sub-grouping 222B represents plants that are relatively shade tolerant having substantially orange blossoms. Sub-groupings 222A and 222B are positioned such that they oppose sub-groupings 226A and 226B which represents plants having complimentary and substantially blue blossoms and which are respectively relatively sun or shade tolerant. Likewise sub-grouping 223A represents plants that are relatively sun tolerant and have substantially red blossoms, while sub-grouping 223B represents plants that are relatively shade tolerant having substantially red blossoms. Sub-groupings 223A and 223B are positioned such that they oppose sub-groupings 227A and 227B which represents plants having complimentary and substantially green blossoms and which are respectively relatively sun or shade tolerant. Finally, sub-grouping 224A represents plants that are relatively sun tolerant and have substantially black blossoms, while sub-grouping 224B represents plants that are relatively shade tolerant having substantially black blossoms. Sub-groupings 224A and 224B are positioned such that they oppose sub-groupings 228A and 228B which represents plants having complimentary and substantially white blossoms and which are respectively relatively sun or shade tolerant.

FIG. 4 also shows sub-grouping 221A divided further into relational sets 221C, 221E and 221G while sub-grouping 221B is divided further into relational sets 221D, 221F and 221H. Each of these sets are based as well on a plant characteristic, in this case relative height. More particularly, sets 221C, 221E and 221G represent plants that are relatively sun tolerant, having substantially yellow blossoms and that will at the time of maturity be of relatively tall, medium and short height respectively. Similarly, sets 221D, 221F and 221H represent plants that are relatively shade tolerant, having substantially yellow blossoms and that will at the time of maturity be of relatively tall, medium and short height respectively. One skilled in the art will appreciate the extent of information that may be communicated to the gardener simply by walking through a center aisle of a physical display comprising a layout of spring perennials array 220 as shown in FIG. 4 and again which may be applied to any of the relational arrangements of the present invention.

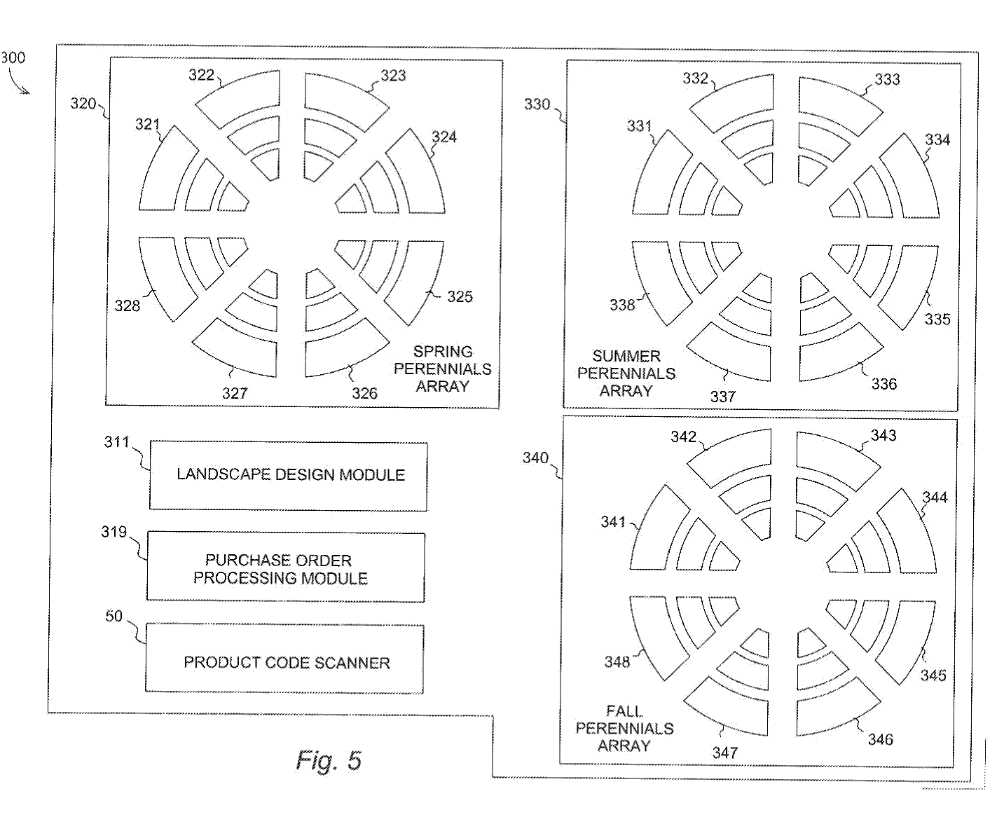

Referring to FIG. 5, a preferred embodiment of plant merchandising system 300 is shown including landscape design module 311, purchase order processing module 318 and a plurality of plant arrays including spring perennials array 320, summer perennials array 330 and fall perennials array 340. Plant merchandising system 300 may also include a handheld scanner 50. FIG. 5 shows a plurality of relational plant arrangements divided in this case not only as to blossom season and predominant blossom color, but in the case of plant merchandising system 300, the various groupings are sorted such that plants having complimentary blossom colors are arranged opposite from one another, providing a visual cue to the gardener or garden planner. In the embodiment shown in FIG. 5, spring perennials array 320, summer perennials array 330 and fall perennials array 340 are arranged to correspond to a layout of a color wheel each comprising a plurality of pie shaped grouping. Referring to spring perennials array 320, grouping 321 represents plants having substantially yellow blossoms and is positioned such that it opposes grouping 325 which represents pants having complimentary and substantially purple blossoms. Grouping 322 represents plants having substantially orange blossoms and is positioned such that it opposes grouping 326 which represents plants having complimentary and substantially blue blossoms. Likewise grouping 323 represents plants having substantially red blossoms and is positioned such that it opposes grouping 327 which represents is plants having complimentary and substantially green blossoms. Finally, grouping 324 represents plants having substantially black blossoms and is positioned such that it opposes grouping 328 which represents plants having complimentary and substantially white blossoms.

Summer perennials array 330 includes grouping 331 which represents plants having substantially yellow blossoms and is positioned opposing grouping 335 which represents plants having complimentary and substantially purple blossoms. Similarly grouping 332 represents plants having substantially orange blossoms and is positioned such that it opposes grouping 336 which represents plants having complimentary and substantially blue blossoms. Likewise grouping 333 represents plants having substantially red blossoms and is positioned such that it opposes grouping 337 which represents plants having complimentary and substantially green blossoms. Finally, grouping 334 represents plants having substantially black blossoms and is positioned such that it opposes grouping 338 which represents plants having complimentary and substantially white blossoms.

Referring to fall perennials array 340, grouping 341 represents plants having substantially yellow blossoms and is positioned such that it opposes grouping 345 which represents plants having complimentary and substantially purple blossoms. Similarly grouping 342 represents plants having substantially orange blossoms and is positioned such that it opposes grouping 346 which represents plants having complimentary and substantially blue blossoms. Likewise grouping 343 represents plants having substantially red blossoms and is positioned such that it opposes grouping 347 which represents plants having complimentary and substantially green blossoms. Lastly, grouping 344 represents plants having substantially black blossoms and is positioned such that it opposes grouping 348 which represents plants having complimentary and substantially white blossoms. As with the linear displays described with reference to FIG. 4, one skilled in the art will appreciate the extent of information that may be communicated to a gardener or shopper standing at a center of a physical display comprising a layout of spring perennials array 320 as shown in FIG. 5 and again which may be applied to any of the relational arrangements of the present invention.

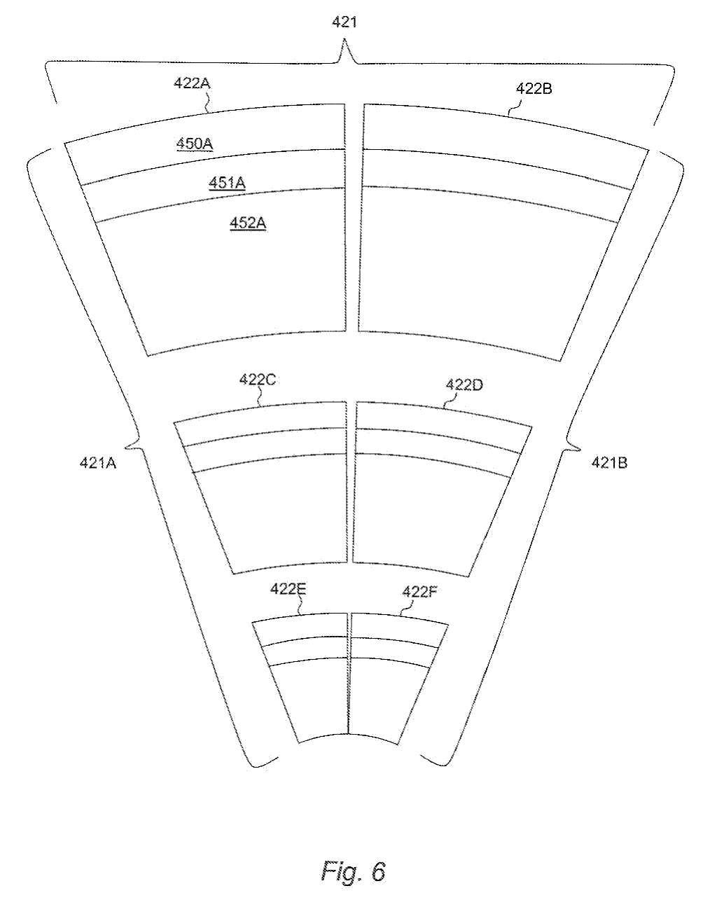

Referring to FIG. 6, grouping 421 represents one of several groupings that would comprise one of a plurality of plant arrays for instance as shown in FIG. 5 as spring perennials array 320, summer perennials array 330 and fall perennials array 340. In this case, grouping 421 of FIG. 6 would be the equivalent to grouping 321 of spring perennials array 320, shown in FIG. 5, having substantially yellow blossoms. Sub-grouping 421A represents plants having substantially yellow blossoms that are sun tolerant while set 421B represents plants having substantially yellow blossoms that are shade tolerant.

Sub-grouping 421A is divided further into relational sets 422A, 422C and 422E while sub-grouping 421B is divided further into relational sets 422B, 422D and 422F. Each of these sets are defined by a particular plant characteristic, in this case relative height. More particularly, sets 422A, 422C and 422E represent plants that are relatively sun tolerant, having substantially yellow blossoms and that will at the time of maturity be of relatively tall, medium and short height respectively. Similarly, sets 422B, 422D and 422F represent plants that are relatively shade tolerant, having substantially yellow blossoms and that will at the time of maturity be of relatively tall, medium and short height respectively.

Grouping 421 which again is representative of several groupings that would comprise one of a plurality of plant arrays for instance as shown in FIG. 5 as spring perennials array 320, summer perennials array 330 and fall perennials array 340 includes additional feature that may assist the gardener in making purchase selections. Each of the sets 422A-422F are further divided into three sections, one including a photographic or pictorial display of the plants available in a given set together with a bar code for the plant and an accompanying written description of the characteristics of the plants available in a given set. With specific reference to set 422A, (which is typical of the layout of sets 422A-422F), set 422A includes pictorial and bar code display 450A, written descriptions 451A and sub-set 452A that provides a display area for actual plants should a shopper prefer to select a plant for purchase.

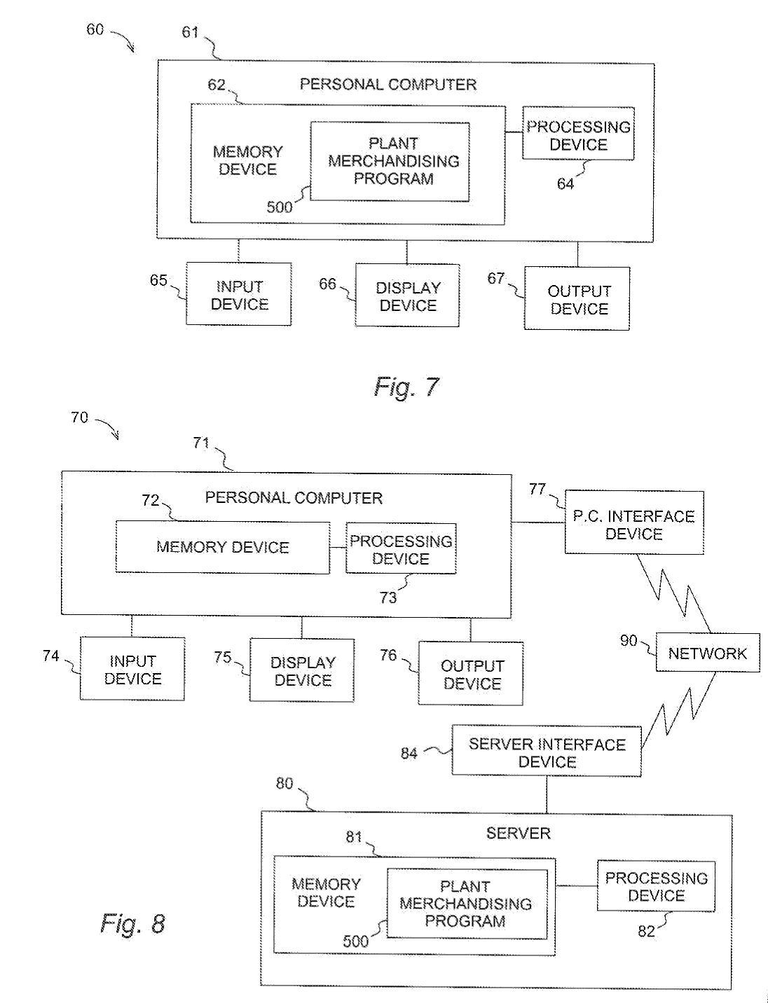

Referring to FIG. 7 the description now turns to computer based plant merchandising system 60 that incorporates the primary features of plant merchandising system 10 described above with reference to FIG. 1. As shown in FIG. 7, computer based plant merchandising system 60 includes a personal computer 61 having a processing device 64 and a memory device 62. Personal computer 61 may take the form of any of a number of available computing devices including portable, handheld and/or stationary. Plant merchandising program 500 is resident on memory device 62 and is operable by processing device 64. As shown in FIG. 7, computer based plant merchandising system 60 may also include input device 65, for example a keyboard or scanning device, display device 66 and output device 67.

FIG. 8 shows a network based version of computer based plant merchandising system 70. As used herein the concept of “network” includes both local area networks as well as the world-wide-web, regardless of protocol. Computer based plant merchandising system 70 includes personal computer 71 having a processing device 73 and memory device 72. Computer based plant merchandising system 70 may also include input device 74, for example a keyboard or scanning device, display device 75 and output device 76. P.C. interface device 77 connects personal computer 71 to server 80 via network 90. Similarly, server interface device 84 connects server 80 to personal computer 71 via network 90. Server 80 includes memory device 81 and processing device 82. Plant merchandising program 500 is resident on memory device 81 of server 80 and is operable by a remote user at personal computer 71 via network 90.

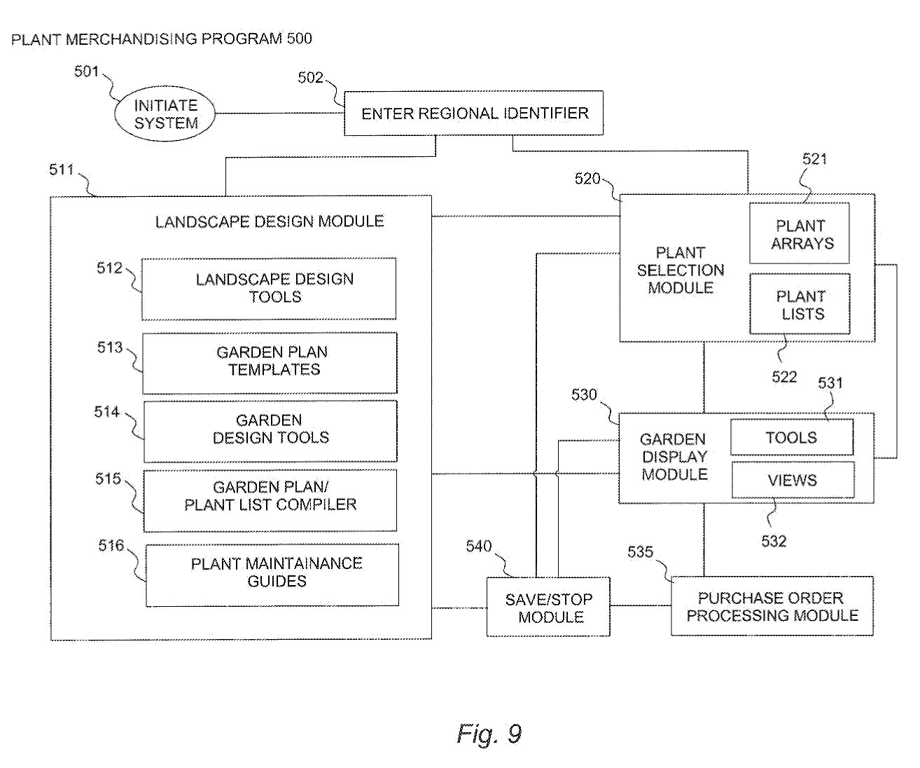

Referring to FIG. 9, plant merchandising program 500 includes several modules that a user is allowed to navigate through freely including landscape design module 511, plant selection module 520, garden display module 530, purchase order module 535 and save/stop module 540. A user initiates the system at initiate system 501 and a prompt is received at enter regional identifier 502 which assists the program in determining initially which geographic area the user intends to make garden design or plant selections for. Landscape design module 511 provides landscape design tools 512 that assist a user in planning landscapes and gardens. The user may input property size and characteristics and garden templates may be selected at garden plan templates 513 or designed by the customer using garden design tools 514. Landscape design module 511 provides information to a user relating to landscape and garden design and plant selection. Garden plan templates 513 provides the user with selectable garden templates or pre-selected garden templates based on limited user input. The user may select one or more pre-designed gardens or plantings from a variety of templates presented at garden plan templates 513.

In the event that the gardener desires to take a more active roll in the design of the planting, landscape design module 511 provides additional tools to assist the gardener. Garden design tools 514 presents information to the gardener that aides in the selection of the planting type desired by the gardener for instance assisting the gardener in determining whether the planting is intended to be established against a backdrop, for example an outer wall of a house or other structure, and if so what the predominant background color may be or whether the planting is to be established in an open area. Additionally, garden design tools 514 may assist the gardener in determining a configuration and size for the planting for which the gardener intends to purchase plants. Garden design tools 514 also assists the purchaser with design decisions relating to the impact that the intended planting is to have, for example, whether the garden or planting is intended as a formal or informal planting. Furthermore, garden design tools 514 assists the gardener in determining a predominant color scheme for the desired planting. Garden design tools 514 may assist the gardener in determining the physical or environmental requirements of the planting. For example the gardener will need to determine the watering requirements for the planting as well as the degree of sun or shade the planting will experience at its intended location. Landscape design module 511 may also include plant maintenance guides 518 that provide the user with information relating to care and maintenance of plants and are made available to assist the gardener in properly caring for the selected plants.

Once a desired landscape and/or garden plan is developed, a garden plan/proposed plant list may be output at garden plan/proposed plant list compiler 515. Garden plan/proposed plant list compiler 515 may provide output in any of a number of formats. For example, output may include simply a printed list of suggested plants and alternatives, or an actual plan template may be printed that not only lists suggested plants and alternatives but indicates the proposed planting location for each plant. The output may be saved and edited by the user.

As shown in FIG. 9, plant merchandising program 500 also includes plant selection module 520 that includes plant arrays 521 and plant lists 522 much the same manner as discussed in connection with the plant merchandising displays discussed with respect to FIGS. 2-6, that is a plant merchandising display wherein plants are displayed in one or more relational plant arrays or other sub-displays including groupings, sub-groupings, sets, sub-sets or the like. Plant arrays 521 may be presented as a photographic or pictorial display of the plants available in a given array. Plant lists 522 provide plant listings and information arranged in a traditional manner, by genus and species. A user, at her option may amend the output at garden plan/proposed plant list compiler 515 by selections made in plant selection module 520. Plant selection module 520 includes drag and drop functionality that permits a user to substitute plants from plant arrays 521 or plant lists 522 with plants listed in the output at garden plan/proposed plant list compiler 515.

Plant merchandising program 500 also includes garden display module 530 that allows a user to view a selected garden or garden template in any of a variety of selectable perspectives or elevations. Garden display module 530 includes drag and drop functionality that permits a user to substitute plants from plant selection module 520 with plants in the selected garden or garden template. Again, a user, at her option may amend the output at garden plan/proposed plant list compiler 515 by drag and drop selections made in garden display module 530.

Purchase documents may be created at a purchase order processing module 535 from the output at garden plan/proposed plant list compiler 515. Details regarding physical selection of plants, cost of the plants and plant pick-up and/or delivery may be arranged for at the purchase order processing module. The user may save a project and/or discontinue the session at save/stop module 540.

The foregoing description of the illustrated embodiments have been presented for purposes of illustration and description. It is not intended to be exhaustive or to limit the invention to the precise form or to exemplary embodiment(s) and implementation(s) disclosed. Numerous modifications and variations will be apparent to practitioners skilled in this art. Process steps described might be interchangeable with other steps in order to achieve the same result. At least one preferred embodiment was chosen and described in order to best explain the principles of the invention and a best mode of practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph unless the element is expressly recited using the phrase “means for . . . ”

What is claimed is:

1. A plant merchandising display comprising one or more relational plant arrays, each of the one or more relational plant arrays including a plurality of plants arranged according to a plant characteristic.

2. The plant merchandising display of claim 1 wherein the plant characteristic further comprises blossom season.

3. The plant merchandising display of claim 1 wherein the plant characteristic further comprises a blossom color.

4. The plant merchandising display of claim 1 wherein the plant characteristic further comprises a complimentary blossom color.

5. The plant merchandising display of claim 1 wherein the plant characteristic further comprises mature plant height.

6. The plant merchandising display of claim 1 wherein the plant characteristic further comprises relative sun/shade tolerance.

7. The plant merchandising display of claim 1 wherein the plant characteristic further comprises plant watering needs.

8. The plant merchandising display of claim 1 wherein the plant characteristic further comprises a garden design objective.

9. The plant merchandising display of claim 1 further comprising a physical display.

10. The plant merchandising display of claim 1 further comprising a virtual display.

11. A plant merchandising system comprising:
a landscape design module; and
a plant merchandising display comprising one or more relational plant arrays, each of the one or more relational plant arrays including a plurality of plants arranged according to a plant characteristic.

12. The plant merchandising system of claim 11 wherein the landscape design module further comprises:
landscape design tools adapted to assist a customer in designing a landscape including one or more gardens;
selectable garden plan templates that may be incorporated in the landscape;
garden design tools adapted to assist a customer in designing a garden that may be incorporated in the landscape; and
a plant directory adapted to assist a customer in selecting plants for the garden.

13. The plant merchandising system of claim 12 further comprising a purchase order processing module adapted to create a purchase order from a selected or designed garden selected or designed at the landscape design module.

14. The plant merchandising system of claim 11 wherein the plant characteristic further comprises blossom season.

15. The plant merchandising system of claim 11 wherein the plant characteristic further comprises a blossom color.

16. The plant merchandising system of claim 11 wherein the plant characteristic further comprises a complimentary blossom color.

17. The plant merchandising system of claim 10 wherein the plant characteristic further comprises mature plant height.

18. The plant merchandising system of claim 11 wherein the plant characteristic further comprises relative sun/shade tolerance.

19. The plant merchandising system of claim 11 wherein the plant characteristic further comprises plant watering needs.

20. The plant merchandising system of claim 11 wherein the plant characteristic further comprises a garden design objective.

21. The plant merchandising system of claim 11 wherein the plant merchandising display further comprises a physical display.

22. The plant merchandising system of claim 11 wherein the plant merchandising display further comprises a virtual display.

23. A computer-implemented plant merchandising system comprising:
a computer operable plant merchandising program operable on the computer, the computer operable plant merchandising program including,
a) a landscape design module including,
i) landscape design tools adapted to assist a customer in designing a landscape including one or more gardens,
ii) selectable garden plan templates that may be incorporated in the landscape,
iii) garden design tools adapted to assist a customer in designing a garden that may be incorporated in the landscape,
iv) a garden plan/plant list compiler adapted to output a plant list of selected plants,
b) a plant selection module including one or more relational plant arrays including a plurality of plants arranged according to a plant characteristic;
c) a garden display module adapted to permit a user to view a selected garden; and
d) a purchase order processing module adapted to process plant list information to create a purchase order.

24. The computer-implemented plant merchandising system claim 23 further comprising a drag and drop feature adapted to permit a user to substitute plants from the plant arrays or plant lists with plants in the selected garden.
